(19) United States
(12) Patent Application Publication
(10) Pub. No.: US 2011/0078169 A1
(43) Pub. Date: Mar. 31, 2011

(54) Electronic Blueprint Evaluation System For Approving Blueprints

(75) Inventor: Ho Wing Sit, Moraga, CA (US)

(73) Assignee: Accela, Inc., San Ramon, CA (US)

(21) Appl. No.: 12/115,441

(22) Filed: May 5, 2008

(51) Int. Cl. G06F 17/30

(52) U.S. Cl. 707/769; 707/822; 707/E17.01; 707/E17.014

(57) ABSTRACT

A method (and system) for electronically approving a blueprint file on a centralized repository. The centralized repository receives or retrieves a blueprint file and extracts from one or more libraries, one or more applicable rules. Each rule is comprised of at least one function and of at least one parameter. An order for evaluating the one or more applicable rules is determined based on a hierarchical score associated with each applicable rule. The one or more applicable rules are evaluated in the determined order and each applicable rule is evaluated using data from the blueprint file. Based on the evaluated one or more applicable rules, the centralized repository determines a recommendation for the blueprint file comprising at least one of rejection, approval, and conditional approval.

### BACKGROUND

1. Field of the Art

This disclosure pertains in general to an electronic blueprint evaluation system (and method) for approving blueprints.

2. Description of the Related Art

A blueprint is a building or architectural plan that is used to construct a building. Typically, blueprints are completed by one or more professionals (e.g., architects) and submitted for approval to one or more government agencies. A reviewer at each agency verifies that a blueprint conforms to various building codes and regulations. Each reviewer verifies that a blueprint conforms to various building codes and regulations by evaluating and examining several aspects of a blueprint (e.g., to determine whether structural, electrical, and heating requirements are met according to local code). This current approval process for blueprints is tedious, long, inconsistent, error prone, inefficient, and expensive.

During the current approval process, blueprints are repeatedly exchanged amongst multiple reviewers and professionals. Figure (FIG.) 1 is a high-level diagram illustrating the current approval process environment 100. Involved in the process are reviewers 102, 104, and 106 and professionals 108, 110, and 112. Each arrow illustrates the exchange of a blueprint between a reviewer and a professional during the current approval process. Although not shown, professionals also exchange blueprints amongst themselves during the current approval process. With blueprints repeatedly exchanged amongst many people during the approval process it is difficult to manage the many versions being circulated of a blueprint then-in-circulation. As illustrated, the process is highly complex and that complexity is problematic, for example, if a professional submits a blueprint to a reviewer to be inspected, but the blueprint is not the latest version.

For example, professional A 108 may be an architect that submits blueprints to reviewer A 102. The reviewer 102 reviews the blueprints and recommends alterations for professional A 108 to make to the blueprints. A second professional B110 (e.g., construction contractor) also needs to review and provide input for the blueprints. If professional B 110 makes any alterations to the blueprints, the blueprints may need to be sent back to reviewer A 102 for approval, or could go to reviewer B 104 for the next phase of approvals. Reviewer B 104 may have further changes for professional A 108 to make, which may affect professional B 110. However, professional B 110 may still be working on changes from reviewer A 102, that are now further impacted by changes caused by the reviewer B 104 and professional A 108 interaction. This complex, non-linear, intertwined review process continues on both sides throughout the professional and reviewer process and interaction.

Thus, the current state of the art lacks, inter alia, an automated and on demand process to efficiently approve blueprints.

### SUMMARY

A method (and system) for electronically approving a blueprint file on a centralized repository. The centralized repository receives or retrieves a blueprint file and extracts from one or more libraries, one or more applicable rules. Each rule is comprised of at least one function and of at least one parameter. An order for evaluating the one or more applicable rules is determined based on a hierarchical score associated with each applicable rule. The one or more applicable rules are evaluated in the determined order and each applicable rule is evaluated using data from the blueprint file. Based on the evaluated one or more applicable rules, the centralized repository determines a recommendation for the blueprint file comprising at least one of rejection, approval, and conditional approval. If the determined recommendation is rejection, the centralized repository determines recommended alteration for the blueprint file. If the determined recommendation is approval or conditional approval, the centralized repository transmits a request for final approval to a reviewer.

The features and advantages described in the specification are not all inclusive and, in particular, many additional features and advantages will be apparent to one of ordinary skill in the art upon viewing the drawings, specification, and claims.

### BRIEF DESCRIPTION OF THE DRAWINGS

Figure (FIG.) 1 is a high-level diagram illustrating the current approval process environment.

FIG. 2 is a high-level diagram illustrating an environment of an electronic blueprint evaluation system according to one embodiment.

FIG. 3 is a high-level block diagram illustrating the electronic blueprint evaluation system according to one embodiment.

FIG. 4 is a flow chart illustrating a method for storing a blueprint file in the electronic blueprint evaluation system according to one embodiment.

FIG. 5 is a flow chart illustrating a method for transmitting a blueprint file stored in the electronic blueprint evaluation system to a professional according to one embodiment.

FIGS. 6A and 6B are a flow chart illustrating a method for approving a blueprint file according to one embodiment.

FIG. 7 is a flow chart illustrating a method for determining and evaluating applicable rules for a blueprint file according to one embodiment.

FIG. 8 is a flow chart illustrating a method for evaluating an applicable rule for a blueprint file according to one embodiment.

FIGS. 9A-9D illustrate how a traditional text based rule is stored and evaluated.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

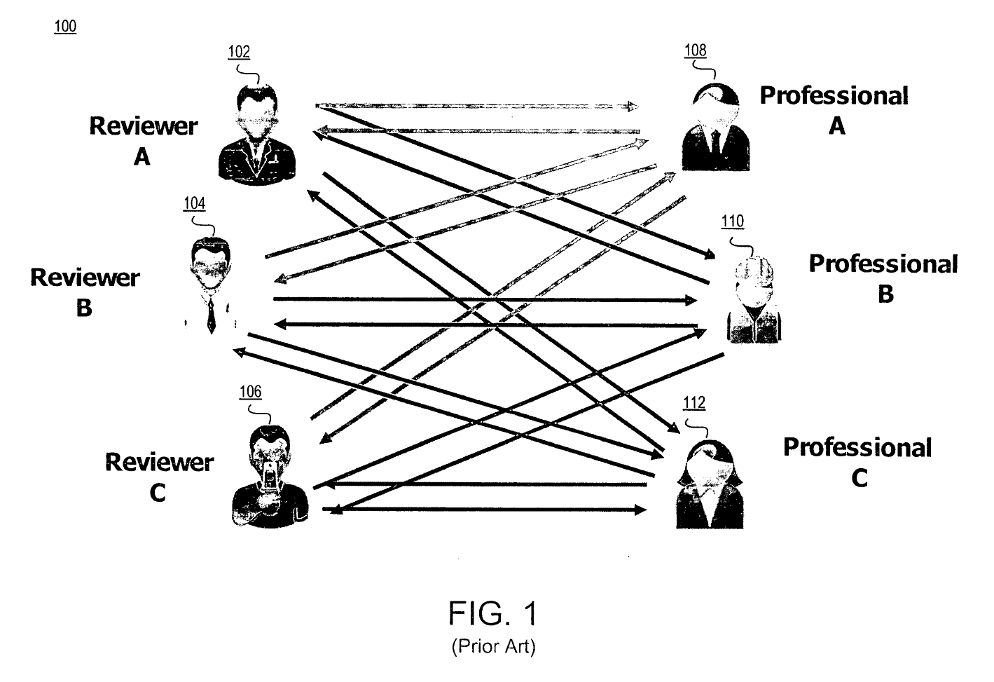

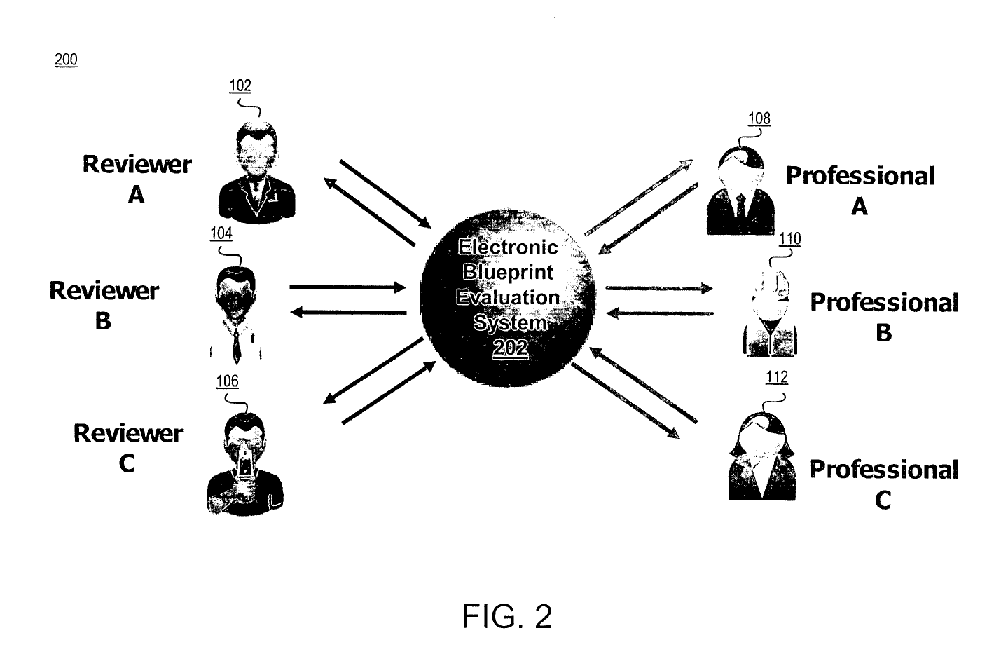

Figure (FIG.) 2 is a high-level diagram illustrating an environment 200 of an electronic blueprint evaluation system (EBES) 202 according to one embodiment. FIG. 2 illustrates reviewers 102, 104, and 106 and professionals 108, 110, and 112 coupled to the electronic blueprint evaluation system 202.

Professionals 108, 110, and 112 represent entities that create or alter blueprint files using a computer system, such as architects, contractors, and engineers. As used herein a “blueprint file” refers to an electronic representation of one or more objects (e.g., walls, windows, doors, electrical, plumbing, elevation, heating, and air conditioning). A blueprint file can, for example, represent an idea, concept, plan, project, map, design, scheme, strategy, layout, schema, outline, or anything else capable of being presented as a viewable representation. In one embodiment, a computer system is used by a professional to create or alter blueprint files. In one embodiment, the computer system is a personal computer executing computerized-aided design (CAD) software. In one embodiment, blueprint files created or altered by professionals using CAD software are two-dimensional (2D) blueprints. In another embodiment, blueprint files created or altered by professionals using CAD software are three-dimensional (3D) models, such as a building information model (BIM), virtual buildings (VB), smart buildings, and object oriented CAD. Additionally, a computer system used by a professional executes a web browser such as MICROSOFT INTERNET EXPLORER that allows the professional to communicate with EBES 202, reviewers, and other professionals.

In one embodiment, a professional can transmit a blueprint file to the EBES 202 for storage in the EBES 202. The professionals can access the blueprint file from the EBES 202 at anytime. Additionally, other professionals with rights to access the blueprint file can request the blueprint file from the EBES 202 for viewing or altering, allowing effortless collaboration between professionals. For example, professional A 108 may create and store a blueprint file in the EBES 202. Professional B 110 can then access the blueprint file from the EBES 202 to alter the blueprint file. A professional can search the EBES 202 and access any blueprint file stored in the EBES 202 to which the professional has rights to access.

At anytime a professional can submit one or more blueprints to the EBES 202 for approval. The approval process executed by the EBES 202 determines whether a blueprint file conforms to applicable building codes and regulations. In one embodiment, a professional can select to submit for approval one or more blueprint files stored on the EBES 202. In another embodiment, a professional transmits one or more blueprint files to EBES 202 with a request to submit the one or more blueprint files for approval.

The EBES 202 represents a central repository that stores a plurality of blueprint files and can on demand execute an approval process to determine whether a blueprint file conforms to applicable building codes and regulations. Upon receiving a blueprint file and a request to store the blueprint file from a professional, the EBES 202 stores the blueprint file received. In one embodiment, the EBES 202 allows the professional to setup which professionals have the right to access the blueprint file from the EBES 202. Additionally, the EBES 202 allows professionals to search the EBES 202 for stored blueprint files and to retrieve a stored blueprint file. In one embodiment, if a professional retrieves a blueprint file stored in the EBES 202, no other professional can access the stored file. For example, if a first professional retrieves a blueprint file to alter the blueprint, the EBES 202 will not allow a second professional to access the blueprint file until the first professional is finished altering the blueprint file. Hence, while the file is under review by a first professional it is locked and cannot be altered by subsequent professionals attempting to retrieve the blueprint file.

The EBES 202 executes the approval process on a blueprint file by identifying and evaluating multiple applicable rules stored in the EBES 202 using data from the blueprint file. It will be apparent that the EBES can execute the approval process on any type of blueprint file, including architectural, structural, elevation, plumbing, electrical, and HVAC (heating, ventilation, and air conditioning) type blueprint files. A blueprint file is always used for the construction of a project (e.g., building, house, school) and all blueprint files that are for the construction of the same project are referred to as a whole as a blueprint set for the project. For example, a blueprint set for the construction of a house may consist of an elevation blueprint file, structural blueprint file, plumbing blueprint file, electrical blueprint file, and HVAC blueprint file. Additionally, blueprint files in a set are interrelated, which means that a change to one blueprint may affect one or more blueprint files in the set. In building blueprint configurations, the blueprints are interrelated. Thus, when the EBES 202 determines which rules to evaluate for a blueprint file, the EBES 202 uses data from the blueprint file and/or from other blueprint files part of the same blueprint set as the blueprint file. For example, when determining the rules to evaluate to a plumbing blueprint file for a house, the EBES 202 will need data about the floors and bathrooms in the house, which is found in the structural blueprint of the house.

The execution of the approval process on a blueprint file results in the blueprint file being rejected, recommended for approval or recommended for conditional approval. The rejection of a blueprint file signifies that the blueprint file does not conform to the applicable rules and regulations. The recommendation for approval of a blueprint file signifies that the blueprint file conforms to the applicable rules and regulations. The recommendation for conditional approval of a blueprint file signifies that the blueprint file conforms to most, if not all applicable rules and regulations, but some alteration needs to be made to the blueprint file.

Reviewers 102, 104, and 106 represent entities that grant final approval to blueprint files that receive approval or conditional approval from the EBES 202. When a blueprint file receives approval or conditional approval from the EBES 202, a reviewer receives a request for final approval from EBES 202. In one embodiment, the request includes a report that indicates which rules were applicable to the blueprint file and an indication as to whether the blueprint file conforms to each evaluated rule. The reviewer uses the report to determine whether EBES 202 was correct in granting the blueprint file approval or conditional approval. This is beneficial in that a reviewer no longer has to evaluate and examine several aspects of a blueprint because it is done by the EBES 202. The reviewer simply has to scan a report and determine whether anything in the report looks out-of-the-ordinary or inconsistent with established practices. If the reviewer grants final approval to the blueprint file, the professional who submitted the blueprint file is notified by the EBES 202 of the approval or conditional approval of the blueprint file. This approval process greatly reduces time needed to determine whether a blueprint file should be approved. In one embodiment, a computer system is used by a reviewer to communicate with EBES 202, professionals, and other reviewers.

It is noted that the user interface for the reviewers and professionals to interact with the EBES 202 in one embodiment are rendered as webpages on the computer system, which can be a personal computer executing a web browser such as MICROSOFT INTERNET EXPLORER or MOZILLA FIREFOX. In one embodiment, the reviewers and professionals are coupled to the EBES 202 via a network (not shown). The network is representative of the communication pathways between reviewers, professionals, and the EBES 202. In one embodiment, the network is the Internet. The network can also utilize dedicated or private communications links that are not necessarily part of the Internet. In one embodiment, the network uses standard communications technologies and/or protocols. Thus, the network can include links using technologies such as Ethernet, 802.11, integrated services digital network (ISDN), digital subscriber line (DSL), asynchronous transfer mode (ATM), etc. Similarly, the networking protocols used on the network can include the transmission control protocol/Internet protocol (TCP/IP), the hypertext transport protocol (HTTP), the simple mail transfer protocol (SMTP), the file transfer protocol (FTP), etc. The data exchanged over the network can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

### System Architecture

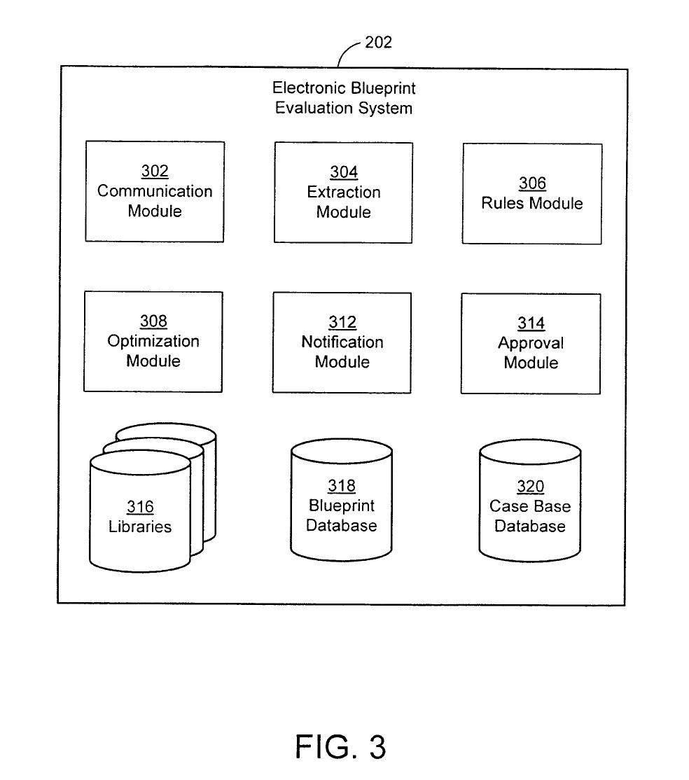

FIG. 3 is a high-level block diagram illustrating the EBES 202 according to one embodiment. The EBES 202 is comprised of an assortment of modules, databases, and libraries. Those of skill in the art will recognize that other embodiments can have different and/or other modules that the ones described here, and that the functionalities can be distributed among modules in a different manner.

As shown in FIG. 3, the EBES 202 includes a communication module 302, which handles communication with professionals and reviewers. In one embodiment, entities other than professionals and reviewers may be given permission by a system administrator to use the services provided by the EBES and communicate with the communication module 302. Upon receiving a blueprint file and a request to store the blueprint file from a professional, the communication module 302 stores the blueprint file in a blueprint database 318. The blueprint database 318 is a database that contains a plurality of stored blueprint files. Prior to storing the blueprint file, the communication module 302 provides the professional with a user interface that allows the professional to name the file and to identify other professionals permitted to access the blueprint file. Identification of the other professionals permitted to access the blueprint file may be done through a setup page on the user interface, in which identification information (e.g., username, email address) for those other professionals is provided. In one embodiment, different levels of access rights can be designated to different professionals. For example, a first professional may be granted rights to access and alter a blueprint file, while a second professional may only be given rights to view, but not alter the blueprint file. In one embodiment, access rights for a blueprint file are stored with the blueprint file in the blueprint database 318 as metadata.

Additionally, through the user interface provided by the communication module 302, a professional that transmits a blueprint file to the communication module 302 for storage can associate the blueprint file with a blueprint set for a project. For example, a blueprint set exists for the construction of a school, Woodside High School. Two blueprint files (e.g., electrical blueprint file and plumbing blueprint file) are stored in the blueprint database 318 and are part of the blueprint set for Woodside High School. When a professional transmits a new blueprint file to the communication module 302 for storage, the professional can choose to make the new blueprint file part of the blueprint set for Woodside High School. In one embodiment, through the user interface a professional can create a new blueprint set for a new project.

For every blueprint set, a professional, e.g., 108, can use the user interface to setup a contact list. The contact list contains contact information for professionals, e.g., 110, 112, that should be contacted by the communication module 302 when a specific event occurs. In one embodiment, the professional, e.g., 108, that sets up the contact list identifies after what events professionals, e.g., 110, 112, on the contact list should be contacted and what type of message should be sent to the professionals (e.g., personalized message).

After a blueprint file is altered, a message is sent to professionals, e.g., 110, 112, on the contact list of the blueprint set that the blueprint file is a part of. For example, a contact list may contain contact information for professionals that have created and stored a blueprint file that is part of the blueprint set for the Woodside High School project. If a first professional retrieves and alters an electrical blueprint file stored in the blueprint database 318, which is part of the blueprint set, the communication module 302 sends a message to professionals on the contact list notifying them that changes were made to electrical blueprint file. This is beneficial because the alterations to the electrical blueprint file may affect a plumbing blueprint file, which is part of the blueprint set. The real-time message sent by the communication module 302 allows the professional that created the plumbing blueprint file to be immediately notified that alterations were made to the electrical blueprint file. The system can be further configured to provide additional details such as whether the changes to the other file have an impact on subsequent blueprints. In one embodiment, the types of messages that can be sent by the communication module 302 to professionals on a contact list are electronic mail messages and text messages.

In one embodiment, through the user interface provided by the communication module 302, professionals can search the files stored in the blueprint database 318. If the communication module 302 receives a request from a professional to access a blueprint file stored in the blueprint database 318, the communication module 302 searches the blueprint database 318 for the requested blueprint file and determines whether the professional has rights to access the blueprint file. If the professional has the proper access rights, the communication module 302 transmits a copy of the blueprint file to the professional. In one embodiment, if a blueprint file stored on the blueprint database 318 has been transmitted to a professional, the communication module 302 will not allow other professionals to access the blueprint file until the professional is finished viewing and/or altering the blueprint file. If a professional accesses a blueprint file, makes alterations to the blueprint file and selects to save the alterations made, the communication module 302 receives the alterations made from the professional and stores the alterations in the blueprint file stored in the blueprint database 318.

An extraction module 304 runs a preliminary check and extracts data from blueprint files that are submitted for approval. When the communication module 302 receives a request from a professional to submit a blueprint file for approval, the extraction module 304 runs a preliminary check on the blueprint file. In one embodiment, the preliminary check involves the extraction module 304 examining the blueprint file to determine whether the blueprint file is in an acceptable format and contains the proper data to go through the approval process.

In one embodiment, there is a sequential order in which blueprint files of a blueprint set must go through the approval process and be approved. In one embodiment, the sequential order is set by a system administrator or by government rules and regulations. The sequential order is sometimes referred to as verification for completeness. Each blueprint file in the sequential order cannot go through approval process until a preceding blueprint file in the sequential order is approved. For example, the following is a sample sequential order: structural blueprint file, plumbing blueprint file, and electrical blueprint file. Based on the sequential order, the structural blueprint file must be the first blueprint file to go through approval process. Once the structural blueprint file is approved, the plumbing blueprint file can go through the automated approval process.

Therefore, as part of the preliminary check of a blueprint file, the extraction module 304 determines the type of the blueprint file (e.g., structural blueprint file, HVAC blueprint file) and identifies other blueprint files stored in the blueprint database 318 that are part of the same blueprint set to which the blueprint file belongs to. The extraction module 304 uses that information to determine whether the blueprint file should be the next blueprint file in a blueprint set to go through the approval process based on the sequential order. If the blueprint file satisfies the predefined requirements of being in the proper format, containing the proper data, and rightfully being the next blueprint file in a blueprint set to go through the approval process, the blueprint file passes the preliminary check.

Otherwise, if the blueprint file does not satisfy the conditions, the blueprint file does not pass the preliminary check and a message is sent by the communication module 302 to the professional that submitted the blueprint file. The message notifies the professional that blueprint file did not pass the preliminary check and includes information as to why the blueprint file did not pass the preliminary check. For example, a message could notify a professional that an electrical blueprint file failed the preliminary check because a structural blueprint must be approved before the electrical blueprint file can be submitted for approval.

Once a blueprint file passes the preliminary check, the extraction module 304 extracts data from the blueprint file and creates a data list containing the extracted data. The extracted data describes objects in the blueprint file, such as a doors, windows, wall, water pipes, and electrical circuits. It should be understood that an object refers to any aspect of a blueprint file. For example, for an object such as a wall, the extracted data will describe the dimensions, material, type, rating and penetration of the wall.

In one embodiment, the extraction module 304 may additionally extract specific data from other blueprint files that are part of the same blueprint set as the blueprint file and have been approved. In one embodiment, for each type of blueprint file, the extraction module 304 must extract specific data from other preceding blueprint files in the sequential order. Since data is being retrieved from preceding blueprint files, it signifies that data is from approved blueprint files. For example, for any plumbing blueprint file, the extraction module 304 must extract data from a structural blueprint identifying the number of floors and the number of bathrooms and kitchens on each floor. The extraction module 304 includes any data extracted from other blueprint files in the created data list.

A rules module 306 receives a data list created by the extraction module 304 for a blueprint file and evaluates applicable rules using data contained in the data list to verify that the blueprint file conforms to applicable building codes and regulations. Upon receiving a data list from the extraction module 304, the rules module 306 identifies data in the data list that must be used as criteria to query libraries 316 for applicable rules. For each type of blueprint file, there is different data that the rules module 306 must identify in the data list. In one embodiment, the identified data includes data extracted from other associated blueprint files. For example, for a plumbing blueprint file, the rules module 306 identifies data in a data list related to the type of building (e.g., commercial office building), the location of the building (e.g., Mountain View, Calif.), the number of floors in the building and the bathrooms and kitchens on each floor. Once the correct data in the data list has been identified, the rules module uses the identified data to query the libraries 316 for applicable rules.

The libraries 316 are databases in a storage device that contain a plurality of stored rules that can be queried and extracted by the rules module 306. The rules in the libraries 316 represent building codes and regulations, which government agencies must enforce on blueprints. In one embodiment, the rules stored in the libraries 316 are created as described in U.S. Pat. No. 7,295,955 to Sit, issued Nov. 13, 2007, entitled “Computer-assisted evaluation of blueprints using computer-storable evaluation-criteria,” the contents of which are incorporated by reference. The applicable rules found are extracted by the rules module 306 and a rules list is created the extracted rules. In one embodiment, each extracted rule has an associated hierarchical score, which is assigned when a rule is created and stored in the libraries 316. The hierarchical score is used by the rules module to order the rules in the rules list. The rules list is arranged by the rules module 306 in a descending order with the first rule in the rules list having the highest hierarchical score and the last rule having the lowest hierarchical score.

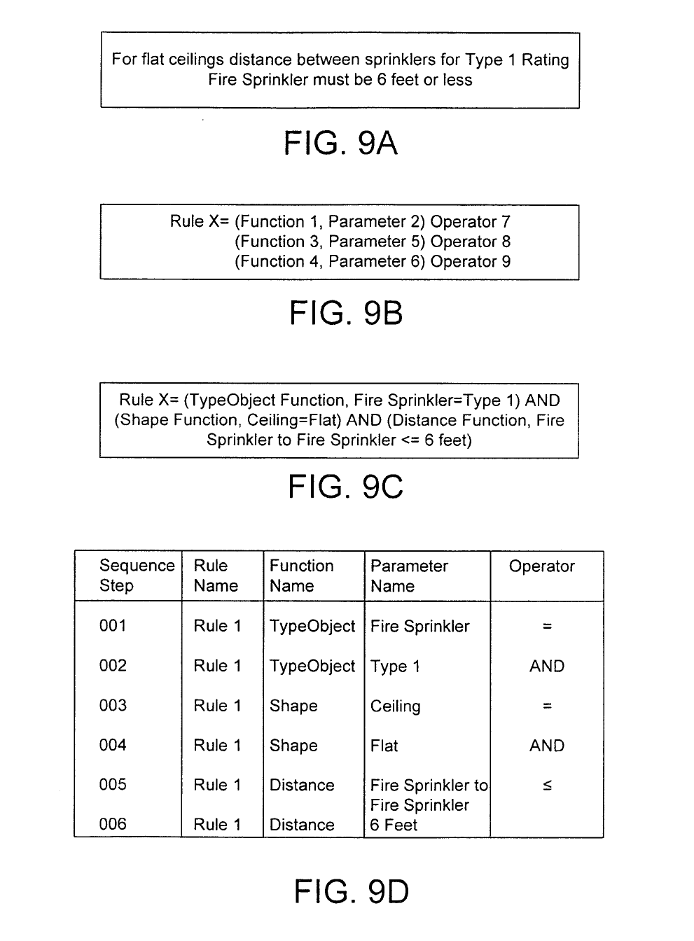

The rules module 306 evaluates each rule in the order in which they are arranged in the rules list. It is beneficial to evaluate the rules in the arranged order because it simulates the process by which a reviewer would evaluate a blueprint. In one embodiment, a rule is comprised of at least one function, at least one parameter and/or at least one operator. Evaluating a rule comprises determining data for the at least one parameter from data list and evaluating the at least one function based on the data of the at least one parameter. Based on the evaluated at least one function it is determined whether the blueprint file conforms to the rule. The rules module 306 tracks whether the blueprint file conforms to a rule on the rules list. The description of FIGS. 9A-9D will provide a detailed example of a rule being evaluated according to one embodiment.

After the rules in the rules list have been evaluated, the rules module 306 determines what the recommendation for the blueprint file should be. In one embodiment, if blueprint file conforms to all rules applied, the rules module 306 recommends the blueprint file for approval and if the blueprint file does not conform to one or more rules the blueprint file is rejected. In another embodiment, if the blueprint file conforms to a number of rules above a threshold value, the rules module 306 recommends the blueprint file for approval. On the other hand, if the blueprint file conforms to a number of rules below a threshold value, the blueprint file is rejected. In one embodiment, if the only rules the blueprint file does not conform to are rules with a hierarchical score below a set score, the rules module 306 will recommend the blueprint file for conditional approval.

An optimization module 308 determines what alterations should be made to a blueprint file that has been rejected by using previously stored data for comparison. The previously stored data may be a table or a database that includes entries that define pre-defined rejections and corresponding pre-defined proposed alterations for the pre-defined rejections. In another embodiment, the data is stored in a case base database 320. The case base database comprises data on blueprint files that were rejected, altered, resubmitted, and approved. For each of those blueprint files the data stored describes the rules that the rejected blueprint file did not conform to and the alterations that were made to the approved blueprint file. In one embodiment, the case base database is a static database that includes data for a set number of blueprint files. In another embodiment, the case base database is a dynamic database. Whenever a blueprint file is approved that was previously rejected by the EBES 202, the optimization module 308 stores data in the cases base database 320 describing the rules that the blueprint file did not originally conform to and the alterations that were made to the approved blueprint file.

When a blueprint file is rejected or recommended for conditional approval by the rules module 306 the optimization module 308 identifies the rules that the blueprint file did not conform to using a rules list associated with the blueprint file. The optimization module 308 uses the identified rules and/or information (e.g., the type of the blueprint file) to query the case base database 320 in order to identify a blueprint file that was rejected for similar reasons. Upon identifying a similar blueprint file, the optimization module 308 retrieves alteration data from the case base database 320 describing the alteration made to the similar blueprint file. The alteration data retrieved by the optimization module 308 is transmitted to a notification module 312.

The notification module 312 creates reports to send to professionals. If a blueprint file has been rejected by the rules module 306, the notification module 312 uses a rules list associated with the blueprint file to create a correction report which indicates the blueprint file has been rejected. The correction report contains the rules evaluated for the blueprint file and indicates for each rule whether the blueprint file conformed to the rule. Additionally, the notification module 312 includes alteration data received from the optimization module 308 in the correction report. The alteration data indicates possible alterations that can be made to the blueprint file in order to be approved. The correction report is transmitted to the professional that submitted the blueprint file to the EBES 202 for approval, in order to notify the professional the blueprint file has been rejected.

Where a blueprint file has been recommended for conditional approval by the rules module 306, the notification module 312 uses a rules list associated with the blueprint file to create a conditional approval report, which indicates the blueprint file was approved but minor alteration are still needed to the blueprint file. Similarly to the correction report, the conditional approval report contains the rules evaluated for the blueprint file and indicates for each rule whether the blueprint file conformed to the rule. Additionally, notification module 312 includes alteration data received from the optimization module 308 in the conditional approval report. The alteration data indicates the minor alterations that must be made to the blueprint file. The conditional approval report is transmitted to a reviewer, e.g., 104, in order for the reviewer to evaluate the conditional approval report and provide the blueprint file with final approval.

Where a blueprint file has been recommended for approval by the rules module 306, the notification module 312 uses a rules list associated with the blueprint file to create an approval report, which indicates the blueprint file has been approved. The approval report contains the rules evaluated for the blueprint file and indicates for each rule whether the blueprint file conformed to the rule. The approval report is transmitted to a reviewer, in order for the reviewer to evaluate the approval report and provide the blueprint file with final approval.

An approval module 314 authenticates blueprint files that have been approved or conditionally approved. In one embodiment, if a reviewer, e.g., 106, wishes to provide final approval for a blueprint file that has been recommended for approval or conditional approval by the rules module 306, the reviewer, e.g., 106, transmits a certificate to the communication module 302. The approval module 314 receives the certificate, identifies a digital signature associated with the reviewer and generates a blueprint signature file. The blueprint signature file contains the digital signature, a copy of the blueprint file that received final approval, and the certificate. The approval module 314 stores the blueprint signature file in the blueprint database 318 and transmits the report associated with blueprint file to the professional, e.g., 108, that submitted the blueprint file for approval. In one embodiment, a blueprint signature file can be accessed for viewing, but cannot be altered. In one embodiment, upon approval, an approved blueprint file and a corresponding blueprint digital signature file created are both frozen and protected from further changes (e.g., files are locked with respect to not being able to make any alterations to the files), so as to ensure authenticity during subsequent legal or other process reviews.

### METHOD/EXAMPLE

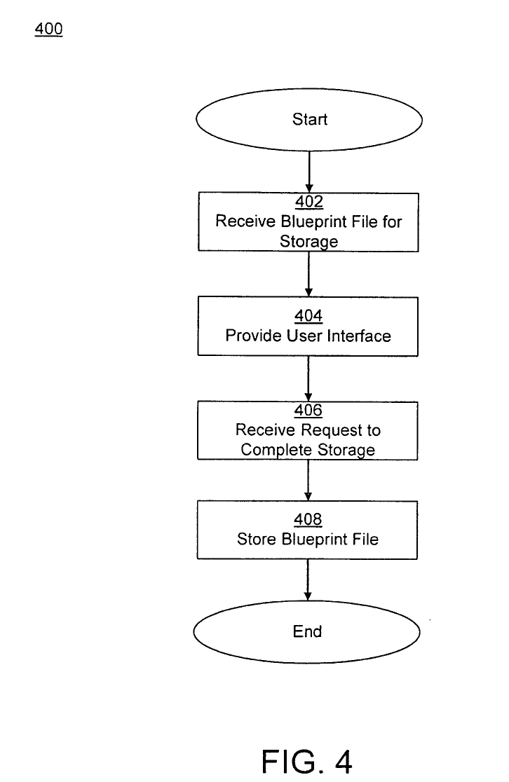

Referring now to FIG. 4, a flow chart illustrates a method 400 for storing a blueprint file in the EBES 202 according to one embodiment. Those of skill in the art will recognize that other embodiments can perform the steps of FIG. 4 in different orders. Moreover, other embodiments can include different and/or additional steps than the ones described here. FIG. 4 illustrates steps performed by the EBES 202 where a professional, e.g., 108, transmits a blueprint file to EBES 202 for storage. In one embodiment, the professional, e.g., 108, uses a web browser to transmit the blueprint file to the EBES 202.

The EBES 202 receives 402 the blueprint file with a request to store the blueprint file. The EBES 202 provides 404 the professional, e.g., 108, with a user interface accessible through a web browser as previously noted. In one embodiment, the user interface allows the professional to name the blueprint file and to setup which other professionals can access the blueprint file. Additionally, through the user interface the professional can associate the blueprint file with a blueprint set for a particular project. If the professional associates the blueprint file with a blueprint set, the professional can create or edit a contact list, which includes contact information for professionals that should be contacted when specific events occur. In one embodiment, the professional sets up the contact list, so that professionals on the contact list are contacted when any of the blueprint files in the blueprint set are altered. When the professional is finished using the user interface, the EBES 202 receives 406 from the professional a request to complete the storage of the blueprint file. The EBES 202 stores 408 the blueprint file in a database associated with the EBES 202.

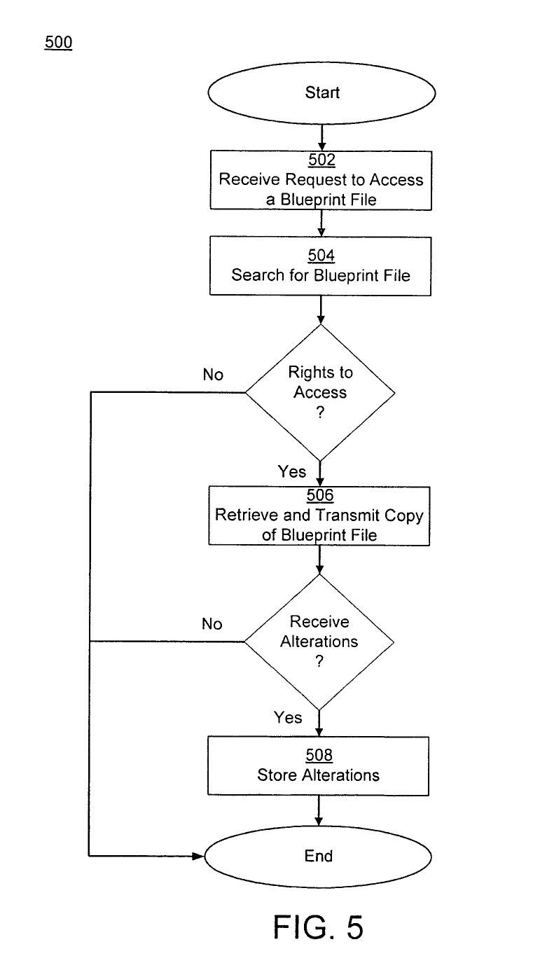

Turning next to FIG. 5, a flow chart illustrates a method 500 for transmitting a blueprint file stored in the EBES 202 to a professional. Those of skill in the art will recognize that other embodiments can perform the steps of FIG. 5 in different orders. Moreover, other embodiments can include different and/or additional steps than the ones described here.

FIG. 5 illustrates steps performed by the EBES 202 in transmitting a blueprint file stored in a database associated with EBES 202 to a professional, e.g., 110. Assume for purposes of this example that the professional, e.g., 110, uses the user interface provided by the EBES 202 to search the EBES 202 for stored blueprint files and selects to access a blueprint file. The EBES 202 receives 502 a request to access the blueprint file. The EBES 202 searches 504 one or more databases associated with the EBES 202 for the blueprint file. Once the blueprint file is found, the EBES examines the metadata of the blueprint file to determine whether the professional, e.g., 110, has rights to access the blueprint file. If the professional, e.g., 110, does not have rights to access the blueprint file, the professional, e.g., 110, is notified that he/she is unable to access the blueprint file. On the other hand if the professional, e.g., 110, has rights to access the blueprint file, the EBES 202 retrieves 506 and transmits a copy of the blueprint file to the professional, e.g., 110.

In one embodiment, if a professional has accessed a blueprint file, no other professional can access the blueprint file until the professional is done viewing and/or altering the blueprint file. Once the professional is finished viewing and/or altering the blueprint file, the EBES 202 makes the blueprint file available for professionals to access. If the EBES 202 receives alterations, meaning that the blueprint file was altered, the EBES 202 stores 508 the alterations in the blueprint file stored in a database associated with the EBES 202. In one embodiment, the alterations cause the EBES 202 to send a message to professionals on a contact list associated with the blueprint file. The message notifies the professionals that the blueprint file has been altered.

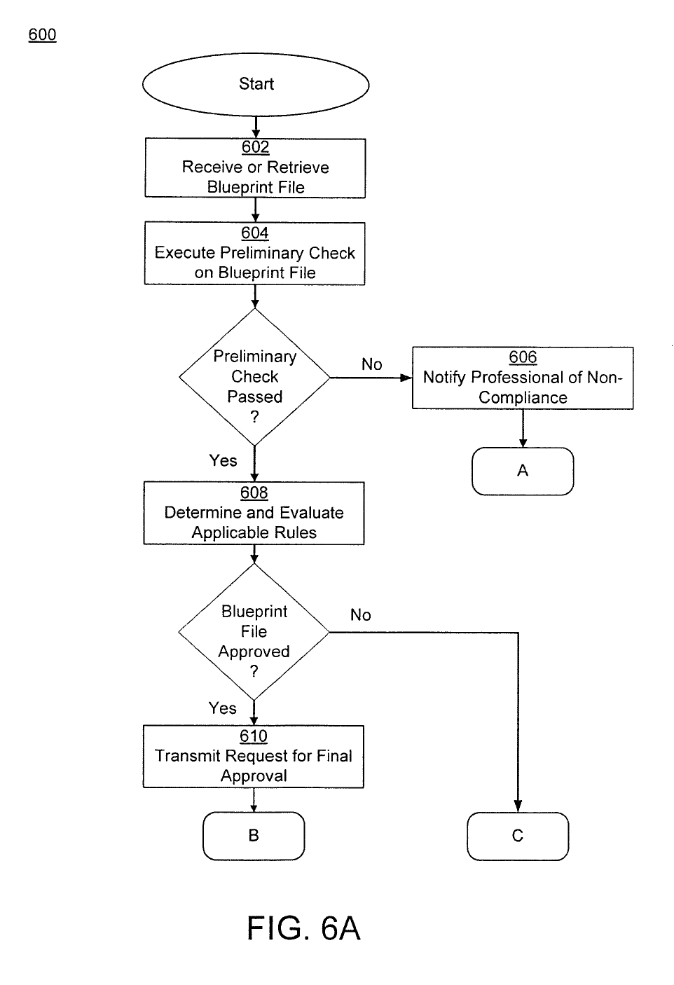

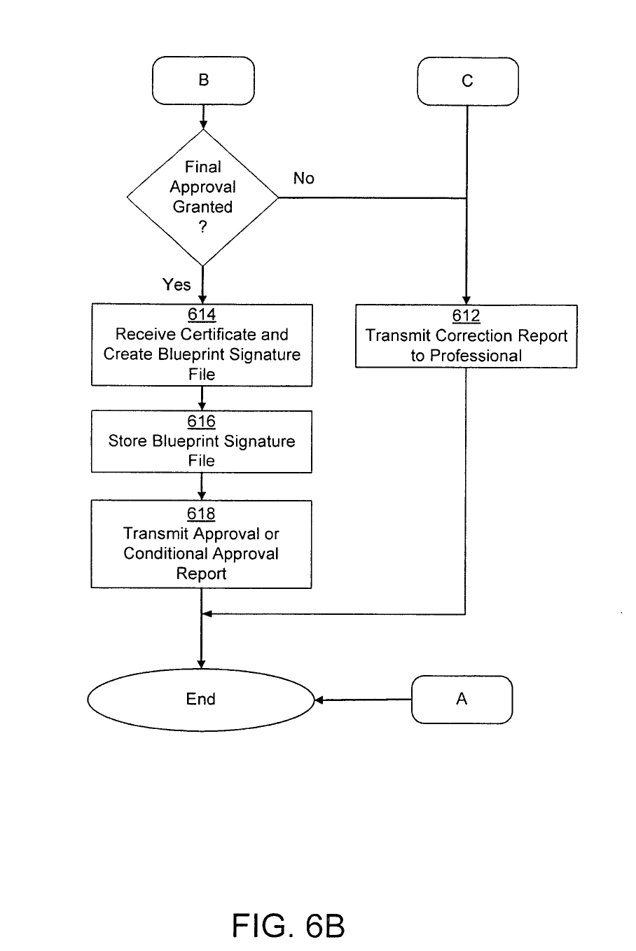

Looking now at FIGS. 6A and 6B, a flow chart illustrates a method 600 for approving a blueprint file according to one embodiment. Those of skill in the art will recognize that other embodiments can perform the steps of FIGS. 6A and 6B in different orders. Moreover, other embodiments can include different and/or additional steps than the ones described here.

FIGS. 6A and 6B illustrate steps performed by the EBES 202 in determining whether to recommend a blueprint file for approval. In one embodiment, a professional transmits the blueprint file to the EBES 202 with a request to submit the blueprint file for approval. In another embodiment, a professional uses the user interface provided by the EBES 202 to select the blueprint file, which is stored in a database associated with the EBES and submits the blueprint file for approval. In one embodiment, once the blueprint file is submitted for approval, the blueprint file cannot be accessed until the approval process for the blueprint file is complete.

The EBES 202 receives 602 or retrieves the blueprint file and executes 604 a preliminary check on the blueprint file. If the blueprint file does not pass the preliminary check the professional is notified 606 that the blueprint file is non-compliant. On the other hand, if the blueprint file passes the preliminary check, the EBES 202 determines 608 and evaluates applicable rules for the blueprint file. Based on the evaluated rules, the EBES 202 determines whether the blueprint is approved. If the blueprint file is not approved, meaning that the blueprint file is rejected, the EBES 202 transmits 612 a correction report to the professional. In one embodiment, the correction report includes suggested alterations that if applied to the blueprint file, may allow the blueprint file to be approved.

Alternatively, if the blueprint file is approved by the EBES 202, meaning that the blueprint file has been recommended for approval or conditional approval, the EBES 202 transmits 610 a final approval request to a reviewer. In one embodiment, the EBES 202 allows the reviewer to access the blueprint file, if a request is received from the reviewer. In one embodiment, the reviewer to which the final approval request is transmitted depends on the type of the blueprint file. In one embodiment, if the blueprint file is approved by the EBES 202, the EBES 202 does not need final approval from a reviewer, instead the EBES notifies the professional that submitted the blueprint file that the blueprint file has been approved or conditionally approved.

If final approval is not granted by the reviewer, the EBES 202 transmits 612 a correction report to the professional that submitted the blueprint file. In one embodiment, the correction report includes comments from the reviewer as to why the blueprint file was rejected. Alternatively, if the blueprint file receives final approval, the EBES 202 receives 614 a certificate associated with the reviewer. The certificate is used by the EBES 202 to create a blueprint signature file. In one embodiment, the blueprint signature files is comprised of the certificate, a digital signature associated with the certificate, and a copy of the approved blueprint file. The method for creating the blueprint signature file is described in detail in U.S. Pat. No. 6,959,382 to Kinnis et al., issued Oct. 25, 2005, entitled “Digital Signature Service,” the contents of which are incorporated by reference.

The EBES 202 stores 616 the blueprint signature file in a database associated with the EBES 202. In one embodiment, the blueprint signature file can be accessed by a professional for viewing, but cannot be altered. In one embodiment, the blueprint file that received approval or conditional approval, can be accessed and altered once the blueprint signature file is stored. In another embodiment, upon approval, an approved blueprint file and a corresponding blueprint digital signature file created are both frozen and protected from further changes (e.g., files are locked with respect to not being able to make any alterations to the files), so as to ensure authenticity during subsequent legal or other process reviews. The EBES 202 transmits 618 an approval or conditional approval report to the professional that submitted the blueprint file for approval.

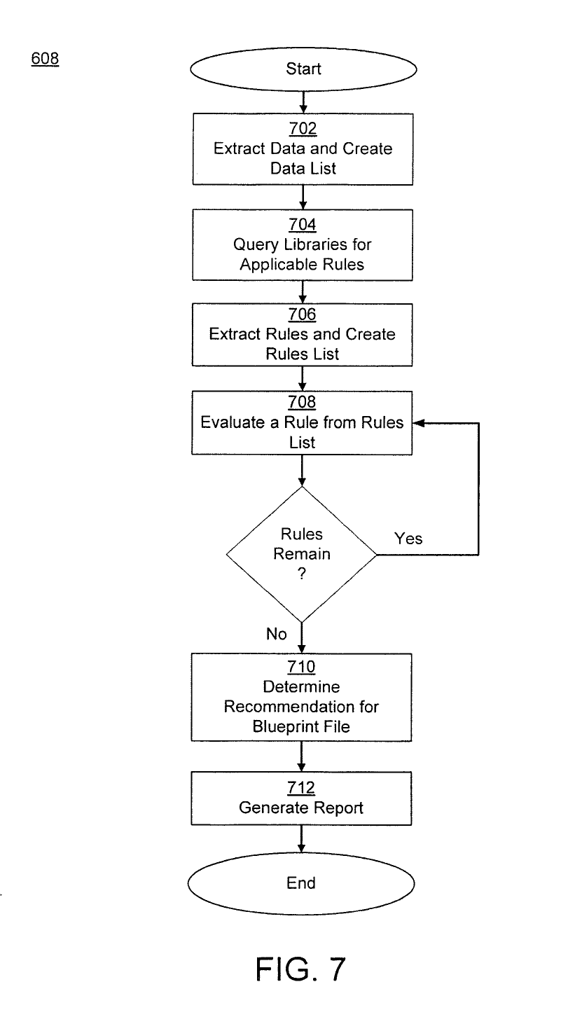

Next, FIG. 7 is a flow chart illustrating a method 608 for determining and evaluating applicable rules for a blueprint file according to one embodiment. The flow chart of FIG. 7 illustrates step 608 of FIG. 6A. Those of skill in the art will recognize that other embodiments can perform the steps of FIG. 7 in different orders. Moreover, other embodiments can include different and/or additional steps than the ones described here. FIG. 7 illustrates steps performed by the EBES 202 in determining and evaluating applicable rules for a blueprint file.

The EBES 202 extracts 702 specific data from the blueprint file and creates a data list that contains the extracted data. In one embodiment, the EBES 202 additionally extracts specific data from other blueprint files that belong to the same blueprint set as the blueprint file. The EBES 202 uses select data from the data list as criteria to query 704 one or more libraries containing a plurality of rules. The EBES 202 extracts 706 any rules that satisfy the criteria and creates a rules list containing the extracted rules. The extracted rules are referred to as applicable rules. In one embodiment, the applicable rules are ordered in the rules list based on a hierarchical score associated with each rule.

The EBES 202 evaluates 708 a rule in the rules list using data in the data list and determines whether the blueprint file conforms to the rule. The EBES 202 determines whether any rules in the rules list still need to be evaluated. If one or more rules remain to be evaluated, the EBES 202 repeats step 708. In one embodiment, the order in which rules are evaluated is based on the order of the rules in the rules list. Alternatively, if no rules remain to be evaluated, the EBES 202 determines 710 the recommendation for the blueprint file based on the evaluated rules. Based on the evaluated rules, the blueprint file is rejected, recommended for approval, or recommended for conditional approval. Once the recommendation for the blueprint file is determined, the EBES 202 generates 712 a report that includes the rules evaluated and the recommendation for the blueprint file.

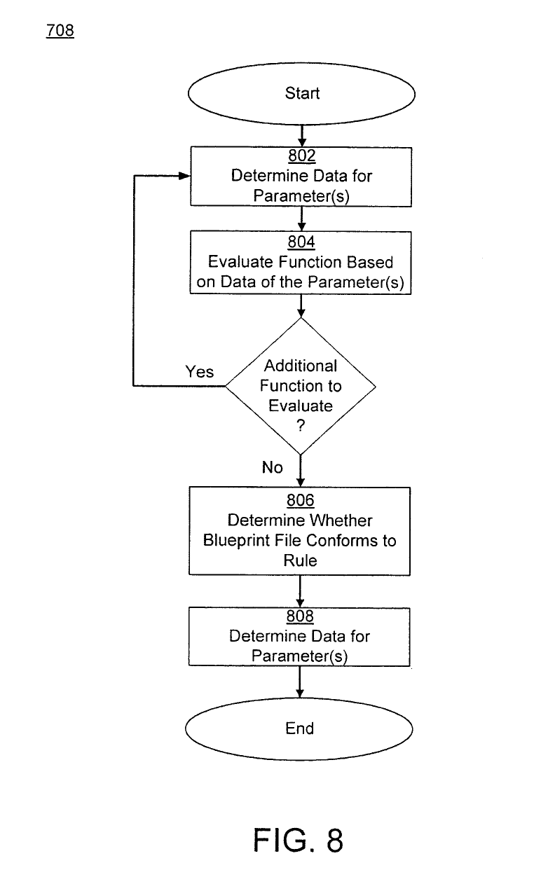

FIG. 8 is a flow chart illustrating a method 708 for evaluating an applicable rule for a blueprint file according to one embodiment, for example, as noted with step 708 of FIG. 7. Those of skill in the art will recognize that other embodiments can perform the steps of FIG. 8 in different orders. Moreover, other embodiments can include different and/or additional steps than the ones described here. FIG. 8 illustrates steps performed by the EBES 202 in evaluating an applicable rule for a blueprint file. Assume for purposes of this example that a rule has been selected to be evaluated using data in a data list associated with the blueprint file. Additionally, assume for purposes of this example that the rule is comprised of one or more functions and of one or more parameters.

The EBES 202 determines 802 data from the data list for the one or more parameters. The EBES 202 evaluates 804 a function based on the on data of the one or more parameters. If there are additional functions that need to be evaluated for the rule, steps 802 and 804 repeat. Alternatively, if no additional functions need to be evaluated, the EBES 202 determines 806 whether the blueprint file conforms to rule based on the evaluated one or more functions. The rules list is updated 808 to indicate whether blueprint file conforms to the rule.

FIG. 9A illustrates an example of a rule, which may be a building code or a government regulation according to one embodiment. The rule requires that “for flat ceilings distance between sprinklers for type 1 rating fire sprinklers must be at least 6 feet or less.” FIG. 9B illustrates the rule, in one embodiment, expressed as a plurality of general, generic, abstract, and/or standard functions (Function 1, Function 3, and Function 4), a plurality of general, generic, abstract, and/or standard parameters (Parameter 2, Parameter 5, and Parameter 6), and similarly a plurality of general, generic, abstract, and/or standard operators (Operator 7, Operator 8, and Operator 9). In one embodiment, these functions, parameters, and operators are stored in the libraries 316 and used interchangeably.

Referring now to FIG. 9C, a function can, for example, be implemented as: a “Type Object” function that determines the type of an object, a “Shape” function that determines the shape of an object, and so on. These functions can be mixed and matched with parameters “Fire Sprinkler,” “Ceiling,” and so on. FIG. 9D depicts a sequence (1-6), which in one embodiment, is stored in the libraries 316 and represent the rule shown in FIG. 9A. For example in the first sequence step the Type Object function searches a data list of a blueprint file to determine data for the parameter Fire Sprinkler. The data determined for the parameter Fire Sprinkler is the type of a fire sprinkler in the blueprint file. In sequence step 2, the TypeObject function determines whether the fire sprinkler object is of type 1 based on the Fire Sprinkler parameter.

In sequence step 3, the Shape function searches the data of the fire sprinkler in the data list to determine data for the Ceiling parameter. The data determined for the Ceiling parameter is the shape of the ceiling to which the fire sprinkler is attached. In sequence step 4, the Shape function determines whether the shape of the ceiling is flat based on the Ceiling parameter. In sequence step 5, a Distance function searches the data list to determine data for a Fire Sprinkler to Fire Sprinkler parameter. The data determined for the Fire Sprinkler to Fire Sprinkler parameter is the distance between the fire sprinkler of sequence step 1 and the next fire sprinkler of the ceiling. In sequence step 6, the Distance function determines whether the distance between the fire sprinklers is less than 6 feet based on the Fire Sprinkler to Fire Sprinkler parameter. Based on evaluation of multiple functions the EBES 202 is able to determine whether the blueprint file conforms to the rule of FIG. 9A.

The system as described herein is beneficial in that provides an organized way for professionals to collaborate on blueprint files. Additionally, the system allows a professional to be aware of any events that that may affect blueprint files that the professional is involved in. The approval process executed by the system is also beneficial in that is an efficient, quick, and streamline way of determining whether blueprint files conform to applicable building codes and regulations. Since reviewers no longer have to evaluate and examine several aspects of a blueprint file, the approval process puts less burden on reviewers.

The described configurations have been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information, for example, in FIGS. 4-8. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Processes described herein also may be embodied as an apparatus for performing the operations herein, such as the processes and functions described in FIGS. 3-8. This apparatus may be specially constructed for the required purposes, or it may comprise a general-purpose computer selectively activated or reconfigured by a computer program stored on a computer readable medium that can be accessed by a processor of the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A method for electronically approving a blueprint file on a centralized repository, the method comprising:
receiving or retrieving by the centralized repository a blueprint file;
extracting from one or more libraries, one or more applicable rules, wherein each rule is comprised of at least one function and of at least one parameter;
determining an order to evaluate the one or more applicable rules based on a hierarchical score associated with each applicable rule;
evaluating the one or more applicable rules in the determined order and using data from the blueprint file to evaluate each applicable rule;
determining, based on the evaluated one or more applicable rules, a recommendation for the blueprint file, the recommendation comprising at least one of rejection, approval, and conditional approval;
responsive to the determined recommendation being rejection, determining recommended alterations for the blueprint file; and
responsive to the determined recommendation being approval or conditional approval, transmitting a request for final approval to a reviewer.

2. The method of claim 1, wherein receiving or retrieving by the centralized repository a blueprint file, further comprises:
executing a preliminary check on the blueprint file to determine whether the blueprint file meets a set of predefined requirements; and
responsive to blueprint file not meeting the set of predefined requirements, notifying a professional that the blueprint file was non-compliant.

3. The method of claim 2, wherein executing a preliminary check further comprises:
determining whether the blueprint file is in proper format and contains proper data; and
determining whether a preceding blueprint file in a sequential order has been approved.

4. The method of claim 1, further comprising:
extracting data from the blueprint file;
querying the one or more libraries for applicable rules using specific extracted data as criteria; and
wherein results from the query are the one or more applicable rules extracted from the one or more libraries.

5. The method of claim 4, wherein extracting data from the blueprint file, further comprises:
extracting select data from one or more associated blueprint files, wherein the one or more associated blueprint files have been approved and are part of a blueprint set to which the blueprint file is associated.

6. The method of claim 5, wherein the select data from the one or more associated blueprint files is used to query the one or more libraries for applicable rules.

7. The method of claim 1, wherein extracting from the one or more libraries one or more applicable rules, further comprises:
creating a rules list containing the extracted one or more applicable rules; and
arranging the one or more applicable rules in the rules list based on the determined order.

8. The method of claim 1, wherein evaluating the one or applicable rules further comprises:
determining data from the blueprint file for the at least one parameter; and
evaluating the at least one function of each rule based on the at least one parameter.

9. The method of claim 1, wherein determining recommended alterations for the blueprint file, further comprises:
querying a database associated with the centralized repository to identify a similar blueprint file that was rejected for similar reasons, but was altered, resubmitted, and approved; and
retrieving from the database alteration data describing alterations made to the similar blueprint file.

10. The method of claim 1, further comprising:
creating a correction report containing the recommended alterations; and
transmitting the correction report to a professional.

11. The method of claim 1, wherein transmitting a request for final approval to a reviewer further comprises:
responsive to receiving a certificate from the reviewer, creating a blueprint signature file comprised of the certificate, an electronic signature associated with the reviewer, and a copy of the blueprint file;
storing the blueprint signature file in the central repository; and
transmitting a report to a professional notifying the professional that the blueprint file has been approved or conditionally approved.

12. The method of claim 11, wherein responsive to determined recommendation being the conditional approval, the report transmitted to the professional indicates alterations that must be made to the blueprint file.

13. A computer program product, comprising a computer readable storage medium having computer program instructions and data embodied thereon to adapt a centralized repository to electronically approve a blueprint file, the computer program instructions executable by a processor to perform the operations of:
receiving or retrieving by the centralized repository a blueprint file;
extracting from one or more libraries, one or more applicable rules, wherein each rule is comprised of at least one function and of at least one parameter;
determining an order to evaluate the one or more applicable rules based on a hierarchical score associated with each applicable rule;
evaluating the one or more applicable rules in the determined order and using data from the blueprint file to evaluate each applicable rule;
determining, based on the evaluated one or more applicable rules, a recommendation for the blueprint file, the recommendation comprising at least one of rejection, approval, and conditional approval;
responsive to the determined recommendation being rejection, determining recommended alterations for the blueprint file; and
responsive to the determined recommendation being approval or conditional approval, transmitting a request for final approval to a reviewer.

14. The computer program product of claim 13, wherein the instructions executable by a processor to perform the operations of receiving or retrieving by the centralized repository a blueprint file comprises instructions executable by a processor to perform the operations of:
executing a preliminary check on the blueprint file to determine whether a preceding blueprint file in a sequential order has been approved; and
responsive to the preceding blueprint file in the sequential order not being approved, notifying a professional that the blueprint file was non-compliant.

15. The computer program product of claim 13, the computer program instructions executable by a processor to further perform the operations of:
extracting data from the blueprint file;
querying the one or more libraries for applicable rules using specific extracted data as criteria; and
wherein results from the query are the one or more applicable rules extracted from the one or more libraries.

16. The computer program product of claim 15, wherein the instructions executable by a processor to perform the operations of extracting data from the blueprint file comprises instructions executable by a processor to perform the operations of:
extracting select data from one or more associated blueprint files, wherein the one or more associated blueprint files have been approved and are part of a blueprint set to which the blueprint file is associated.

17. The computer program product of claim 13, wherein the instructions executable by a processor to perform the operations of determining recommended alterations for the blueprint file comprises instructions executable by a processor to perform the operations of:
querying a database associated with the centralized repository to identify a similar blueprint file that was rejected for similar reasons, but was altered, resubmitted, and approved; and
retrieving from the database alteration data describing alterations made to the similar blueprint file.

18. A system for electronically approving a blueprint file on a centralized repository, the system comprising:
a communication module configured to receive or retrieve by the centralized repository a blueprint file;
a rules module configured to:
extract from one or more libraries, one or more applicable rules, wherein each rule is comprised of at least one function and of at least one parameter;
determine an order to evaluate the one or more applicable rules based on a hierarchical score associated with each applicable rule;
evaluate the one or more applicable rules in the determined order and using data from the blueprint file to evaluate each applicable rule; and
determine, based on the evaluated one or more applicable rules, a recommendation for the blueprint file, the recommendation comprising at least one of rejection, approval, and conditional approval;
an optimization module configured to determine recommended alterations for the blueprint file, responsive to the determined recommendation being rejection; and
a notification module configured to transmit request for final approval to a reviewer, responsive to the determined recommendation being approval or conditional approval.

19. The system of claim 18, further comprising:
an extraction module configured to execute a preliminary check on the blueprint file to determine whether a preceding blueprint file in a sequential order has been approved; and
the communication module further configured to notify a professional that the blueprint file was non-compliant, responsive to the preceding blueprint file in the sequential order not being approved.

20. The system of claim 18, further comprising:
an extraction module configured to extract data from the blueprint file; and
the rules module further configured to query the one or more libraries for applicable rules using specific extracted data as criteria, wherein results from the query are the one or more applicable rules extracted from the one or more libraries.

21. The system of claim 20, wherein the extraction module is further configured to extract select data from one or more associated blueprint files, wherein the one or more associated blueprint files have been approved and are part of a blueprint set to which the blueprint file is associated.

22. The system of claim 18, wherein the optimization module is further configured to:
query a database associated with the centralized repository to identify a similar blueprint file that was rejected for similar reasons, but was altered, resubmitted, and approved; and
retrieve from the database alteration data describing alterations made to the similar blueprint file.
